(19) United States
(12) Patent Application Publication
(10) Pub. No.: US 2006/0033824 A1
(43) Pub. Date: Feb. 16, 2006

(54) Sodium screen digital traveling matte methods and apparatus

(76) Inventor: Bruce A. Nicholson, San Anselmo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/200,629

(22) Filed: Aug. 9, 2005

Related U.S. Application Data
(60) Provisional application No. 60/600,670, filed on Aug. 10, 2004.
(60) Provisional application No. 60/633,771, filed on Dec. 3, 2004.

(51) Int. Cl. H04N 9/09; H04N 9/74

(52) U.S. Cl. 348/265; 348/587

(57) ABSTRACT

A digital video camera comprises, a region receiving multifrequency light, a first CCD receiving red light and converting red light into first electrical signals, a second CCD receiving blue light and converting blue light into second electrical signals, a third CCD receiving green light and converting green light into third electrical signals, a fourth CCD receiving sodium light (wavelengths of light from a low-pressure sodium vapor light) and converting the light into fourth electrical signals, in real-time, and a prism receiving multifrequency light and directing red light, blue light, green light and sodium light to respective first, second, third, and fourth CCDs.

### CROSS-REFERENCES TO RELATED APPLICATIONS

The present invention claims priority to and incorporates by reference for all purposes U.S. Provisional No. 60/600,670, filed Aug. 10, 2004 and U.S. Provisional No. 60/633,771, filed Dec. 3, 2004.

### BACKGROUND OF THE INVENTION

The present invention relates to methods and apparatus for visual effects. More specifically, the present invention relates to digital traveling matte processes and apparatus.

The inventor of the present invention has been involved in the film industry for approximately thirty years. Most of the inventor's work has involved visual effects based upon traveling matte processes. Notable features the inventor has worked on have included The Day After Tomorrow (2004), Armageddon (1998), Field of Dreams (1989), Star Wars: Episode VI—Return of the Jedi (1983), Indiana Jones and the Temple of Doom (1984), Poltergeist (1982), Star Wars (1977), and others. His contributions in the industry have been recognized by the Academy of Motion Pictures with an Oscar™ for Best Effects/Visual Effects for Raiders of the Lost Ark (1981), and a Special Achievement Award and Oscar™ for Visual Effects for Star Wars: Episode V—The Empire Strikes Back (1980).

In the film industry, the term traveling matte process typically refers to the compositing of traveling (moving) images (e.g. live actors) and background/foreground images. The background/foreground images are typically hand-painted or a digitally constructed images representing make-believe locations, real-locations, or the like. These images are typically combined based upon one or more “traveling matte images.” By using matte images, for example, the inventor has placed Captain Kirk on the Genesis Planet in Star Trek: The Wrath of Khan (1982). As another example, by using a matte images, the inventor has placed a haunted house in the middle of Seattle in Rose Red (2002).

Well-known traveling matte processes include the use of “blue screens” or “green screens” to help define or delineate areas in a matte image that refer to one or more foreground images and that refer to one or more background images. As illustrated in FIG. 1, a typical blue or green screen process includes initially filming an actor, for example, in front of a blue-colored or green-colored screen, step 10. The film is then developed and copied, step 20, and an initial matte extraction process is then performed, step 30.

As is known in the industry, matte extraction process typically includes attempting to determine which locations on each image represent the foreground and/or which part represents the background. The inventor has determined that the greatest challenge in this process is in determining the boundary between the foreground and background. A common term for this challenge is “edge characteristics,” step 40. The matte is then modified, step 50.

Next, in typical embodiments, the foreground image and a background image are combined to form a composite image, step 60, based upon the matte image. In various techniques, the foreground image and the background image are formed by combining the matte with the developed film or the background image, respectively.

Drawbacks to the blue or green screen matting process includes that it is a time consuming process and there is a slow turn-around. As example, after a scene is shot, the exposed film must first be developed, before the film can be even viewed. Additionally, conventional matte extraction processes are typically performed by powerful hardware and sophisticated software from images on the developed film. The matt extraction processes typically occur “off-line,” and in “post-production” well-after the film has been shot. Accordingly, when there are problems with the blue or green screen backgrounds, which the Inventor has personally seen in every feature he has worked on, by the time such problems are discovered, the shot cannot be refilmed. Some of the problems experienced by the inventor has included seams being visible in a blue or green screen background, full-spectrum front lights projected onto the actors washing out the blue or green lights of the screen, undesirable shadows being cast upon the blue or green screen, the actors being too close to the background inhibiting the blue or green lights hitting the screen, thin objects not being clearly front-illuminated, objects filmed out of focus, and the like.

Another problem experienced by the Inventor of the present invention has included fixing many problems with “spill” through, e.g. problems in determining edges between objects and background. Typical areas where spill is notable includes reflective surfaces of fore-ground objects, hair or other types of fluffy material, leaves, fine structures such as thin objects, and the like. Typical spill through defects can be seen in an image as an unattractive blue or green halo (or “matte line”) around a foreground object, a foreground object or portions thereof being partially transparent, or the like.

Yet another drawback to the blue or green screen matting process is that it constrains the selection of colors in the scene. As is known in the industry, the blue or green screen process relies upon a filtering process that filters-out a wide range of colors in the blue region of the spectrum or and a wide range of colors in the green region of the spectrum. As an example, in FIG. 2A, a typical spectrum 21 used for blue screen processes is shown. A similar-type of spectrum is used for green screen processes.

In FIGS. 2A and 2B, the vertical axis of the graph measures the relative energy radiated by the source, and the horizontal axis shows the wavelength range of the source measured in nanometers. The visible light spectrum is considered to range from 380 to 700 nanometers (nm), with blue ranging from 400-500 nm, green 490-560 nm, yellow 560-590 nm, and red 600-700 nm. As can be seen, the blue screen lamp 21 is spread in varying degrees throughout the entire blue range, 400-500 nanometers. As can be seen, the spectral energy distribution of a low pressure sodium lamp 22 is extremely narrow, 589-590 nanometers.

A problem with dedicating large portions of the spectrum for blue or green screens includes that the director, set director, wardrobe director or the like, must be sure that the foreground characters, or sets do not include any colors within this blue region of the spectrum or green region of the spectrum. For example, using the blue screen process, compositing an astronaut holding an American flag on an image of the surface of Mars may have difficulties because of the blue color of the flag may be interpreted as part of the blue-screen; as another example, using a green screen process, compositing an actor holding a green apple on an image of the interior of the Titanic may have difficulties because of the green color of the apple may be interpreted as part of the green-screen. Many other color-type conflicts may also be envisioned. Another drawback was that colors of certain fabrics, materials, etc. appear different in color when blue or green frequencies of light are suppressed using the process described above. Accordingly, the resulting composited image may unacceptably have object colors that do not reflect what was painstakingly specified.

One innovation in the traveling matte process was the use of a sodium screen process. This process was developed by Petro Vlahos, and is described in U.S. patents in his name including U.S. Pat. No. 3,095,304, Jun. 25, 1963, and others. The sodium screen process operated in substantially the same way described in FIG. 1, above. A difference was that the initial matte extraction process of step 30 was performed at the same time as step 20. As described in the '304 patent, a prism, was developed that was affixed in front of a camera film plane. The prism allowed filtered light within a narrow region (sodium region) of light to be recorded onto black and white film stock which is used to represent the initial matte, and light outside the narrow region to be recorded onto color film stock. These two exposed film images were then developed and used as described in FIG. 1, above, to form a composite image.

One advantage of the use of sodium screen process over blue or green screen process was that the range of frequencies of sodium light was very narrow. As can be seen, the spectral energy distribution of a low pressure sodium lamp 22 in FIG. 2B is extremely narrow, 589-590 nanometers. Further, the sodium wavelengths are situated near the middle of the visible color spectrum, making them an accessible range to capture.

Drawbacks of the sodium screen process that limited the industry use of the process included that by introducing light splitting unit (prism) into a typical film camera the length of the lenses that could be used in such a camera had to increase. As illustrated in FIGS. 3A and 3B, the focal length of the lenses used with the film camera had to increase with the addition of a large prism and an additional film plane (matte film plane). Because of the increase focal length of the lenses, the film cameras had to be positioned further away from the actors and action than was desirable.

Additionally, as the focal length increased, the derived f-number (f-stop) also increased. For example, in FIG. 3A, if a lens had an f-number of f/4 (diameter/focal length), and the focal length increased by a factor of 2, the f-number becomes f/8. As can be seen, the lens used in the film camera in FIG. 3A becomes slower, and is less able to capture low-light images when used in the film camera in FIG. 3B. As a result, larger, more-costly and lower f-number lenses had to be manufactured and used with this sodium screen processes, in part because of the increase in focal length. The inventor believes that only a handful of lenses were ever produced for such cameras.

Another drawback to the sodium screen process that dramatically limited the industry use of the process was that beam splitters and filters used to filter-out light within the sodium region of the spectrum dramatically decreased transmission of light of all wavelengths reaching the film plane. In particular, the inventor understands that in practice, light transmission to the film pane dramatically decreased by about two f-stops. In other words, the intensity of light was decreased by approximately 75%, by the time the light struck the film stock. Additionally, because film stock was very slow to begin with, for example ASA rating of ISO 50, this decrease in light transmission was very problematic.

To compensate for the decrease in light transmission to film stock because of the sodium screen process, the intensity of light striking the lens had to be increased by 4 times. More specifically, the intensity of light shinning on the foreground actors, objects and the backing had to increase by about 4 times. Such increases in spot lighting was highly undesirable because it was very difficult to achieve, was uncomfortable for the actors and interfered with director creativity. Additionally, such increases in lighting made it difficult to achieve continuity between different shots or scenes in a feature. Accordingly, increasing the amount of lighting was not a viable solution.

Yet another drawback to the sodium screen process that dramatically limited the industry use of the process was that patents were issued that locked-up the use of the process from the rest of the film industry. For example, as noted above, Petro Vlahos developed and patented many applications to sodium screen processes. Many of these patents were used by the Walt Disney company for some of their features in the 50's and 60's, before falling into disuse. Accordingly, many in the film industry “grew-up” using blue or green screen processes to perform compositing, avoiding the patented sodium screen process. In light of the above, the inventor has recognized that sodium screen processes and technology has fallen by the way-side and is not currently in use in the film industry. Further, many, if not most, in the industry do not currently even consider using sodium screen technology for visual effects.

The film industry is currently beginning a transformation from recording images onto film stock to recording images onto digital media. As an example, high resolution digital video cameras, such as the Sony HDC-F950, have become a widely used camera for high-definition (HD) digital recording. As is common with higher-performance video cameras, such cameras include three CCD arrays which output three images including one image from the red region of the spectrum, one image from the green region of the spectrum, and one image from the blue region of the spectrum. Internally, a prism assembly is used to split light into these component color regions.

Currently, blue and green screen processes are being used with HD digital images. In contrast to film, digital images can be viewed immediately after the scene is shot, however, the drawbacks of blue and green screen processes, described above, are still equally applicable. For example, the blue and green matting processes is typically performed well after shooting has ended, thus problems with backgrounds, extraneous light, and the like, that could be easily fixed during a shot, have to be painstakingly fixed off-line.

Some matting systems such as provided by Ultimatte Corporation provide some measure of blue and green screen processing on-set, but not in real-time. Such systems are very limited because they still rely upon software matte extraction algorithms upon the broader blue-region spectrum and/or green-region spectrum. Because of this, such systems still suffer the same problems and drawbacks of conventional blue and/or green-screen matting, described above. Additionally, such dedicated hardware and software systems are complicated due the great number of software adjustable parameters and are very costly.

Accordingly, the use of digital video cameras have not acceptably simplified the problems with blue and green screen processes.

In light of the above, what is desired are methods and apparatus for addressing the problems described without the drawbacks described above.

### BRIEF SUMMARY OF THE INVENTION

The present invention relates to visual effects. More specifically, the present invention relates to novel digital video cameras having the ability to provide sodium screen traveling mattes in real-time.

The embodiments describe, a traveling matte process for digital cinema, utilizing a sodium illuminated backing to enable real-time digital extraction of a traveling matte of a foreground live action subject. The traveling matte allows users to composite foreground subject along with one or more separately recorded background images more easily, with higher quality, and lower post-production costs. In various embodiments, the matte is recorded as an alpha channel in a High Definition Digital Camera by means of a filter which records and transmits wavelengths of light primarily produced by low-pressure sodium vapor lighting sources.

According to one aspect of the present invention, a novel digital video camera is described. One apparatus includes a light receiving region configured to receive light having a plurality of frequencies in the form of an image, wherein the light receiving region is also coupled to receive a lens. Another device, includes a first CCD element configured to receive light within a red region of light spectrum, and configured to convert received light into first electrical signals, a second CCD element configured to receive light within a blue region of the light spectrum, and configured to convert received light into second electrical signals, a third CCD element configured to receive light within a green region of the light spectrum, and configured to convert received light into third electrical signals, and a fourth CCD element configured to receive light within a sodium region of the light spectrum, wherein the sodium region of the light spectrum comprises a region of spectrum of light provided by low-pressure sodium vapor light, and wherein the fourth CCD element is configured to convert received light into fourth electrical signals. Various devices also include a prism coupled to the light receiving region, to the first CCD element, to the second CCD element, to the third CCD element, and to the fourth CCD element, wherein the prism is configured to receive the light at in input portion, and direct the light within the red region to the first CCD element in response to the light, direct the light within the blue region to the second CCD element in response to the light, direct the light within the green region to the third CCD element in response to the light, and direct the light within the sodium region to the fourth CCD element in response to the light.

According to another aspect of the invention a method for an imaging device is described. One process includes receiving in a lens assembly an image comprising light having a plurality of wavelengths, directing the light having a plurality of wavelengths into a prism, and providing light having wavelength within a sodium region of a spectrum to a first semiconductor optical sensor from the prism in response to the light having the plurality of wavelengths, wherein the sodium region of the light spectrum comprises a region of spectrum of light provided by low-pressure sodium vapor light. Techniques may include providing light having wavelength within a blue region of a spectrum to a second semiconductor optical sensor from the prism in response to the light having the plurality of wavelengths, providing light having wavelength within a red region of the spectrum to a third semiconductor optical sensor from the prism in response to the light having the plurality of wavelengths, and providing light having wavelength within a green region of the spectrum to a fourth semiconductor optical sensor from the prism in response to the light having the plurality of wavelengths.

According to yet another aspect of the invention, a digital camera is described. The apparatus may include a light receiving region configured to receive light having a plurality of wavelengths, and a first sensor element configured to receive sodium-region wavelengths of light, wherein the sodium-region wavelengths of light comprises wavelengths of light provided by low-pressure sodium vapor lights, wherein the first sensor element is configured to convert primarily the sodium-region wavelengths of light into a matte image in real-time. Various devices may also include a second sensor element configured to receive remaining-region wavelengths of light, wherein the remaining-region wavelengths of light comprise the light having the plurality of wavelengths with attenuated sodium-region wavelengths of light, wherein the second sensor element is configured to convert the reaming-region wavelengths of light into a color image in real-time, and a prism coupled to the light receiving region, to the first sensor element and to the second sensor element, wherein the prism is configured to receive the light at in input portion, direct the light within the sodium-region wavelengths of light to the first sensor element in response to the light, and direct the remaining-region wavelengths of light to the second sensor element in response to the light.

Methods for forming a digital video camera having RGB and Sodium channels is also described below, further, methods for forming a single substrate with RGB and Sodium filters is described below. Two specific configurations include a planar cell array and a multi-layer planar cell array.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings.

FIG. 1 illustrates a typical blue or green screen process;

FIGS. 2A-B illustrate typical spectrums of light for blue and sodium screen lighting;

FIGS. 3A-B illustrate effects of sodium screen hardware on film camera focal length;

FIG. 4 illustrates one embodiment of the present invention;

FIGS. 5A-C illustrate thee-dimensional representations of visible color space;

FIG. 6 illustrates an example according to an embodiment of the present invention;

FIGS. 7A-C illustrate another embodiment of the present invention;

FIGS. 8A-B illustrates a process according to an embodiment of the present invention; and

FIGS. 9A-B illustrate alternative embodiments of the present invention.

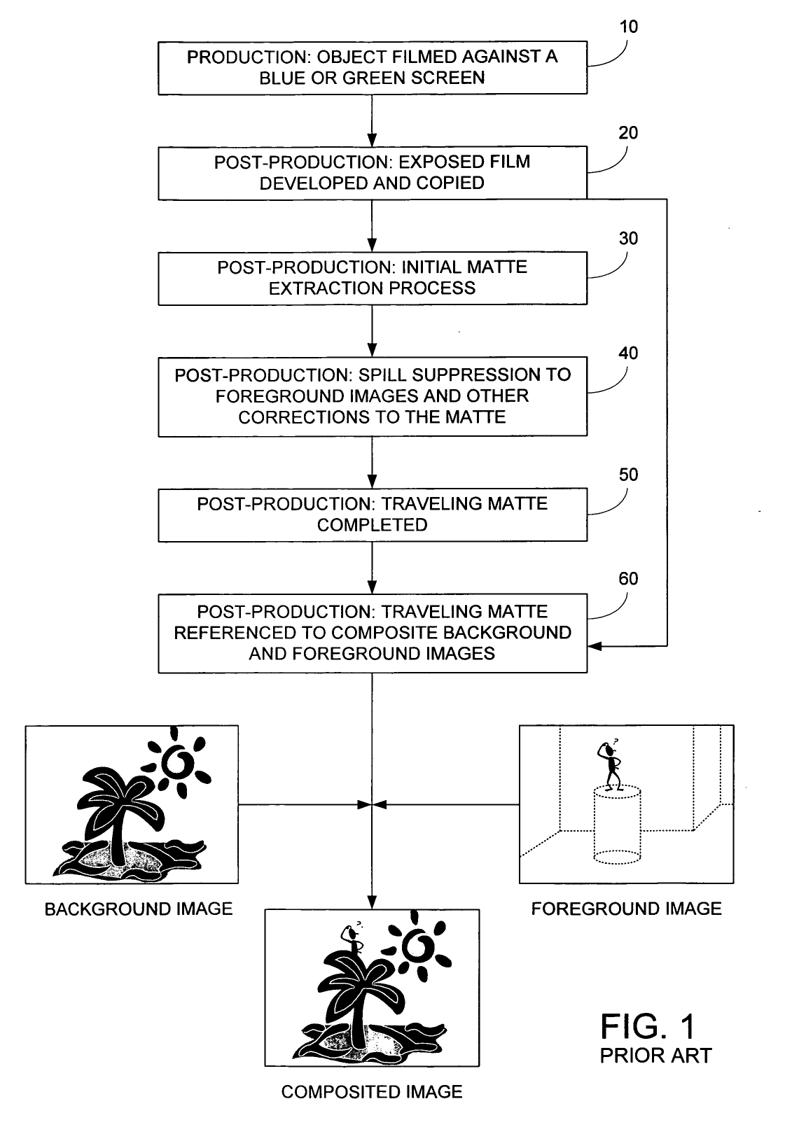

### DETAILED DESCRIPTION OF THE INVENTION

More specifically, FIG. 4 provides a perspective view of an imaging device 18 configured to digitally record a foreground subject against a sodium illuminated backing. In various embodiments, imaging device 18 is a high-definition (HD) digital video camera that provides real-time sodium screen traveling matte data, in addition to conventional color image data. In other embodiments, imaging device 18 may be any digital camera such as broadcast-grade digital video camera, a consumer-grade video camera, a still digital camera, or the like.

In this example, foreground subject 14, an 18% gray clock, is illuminated with tungsten (full-spectrum) illumination sources 16A and 16B, commonly used in the motion picture industry. Additionally, a backing 11 of material, such as cotton or muslin material, or any other surface, is painted a primary yellow color and mounted on a support system, such as a wooden or steel frame. In this embodiment, backing 11 is then illuminated with low pressure sodium vapor illumination sources 12A and 12B.

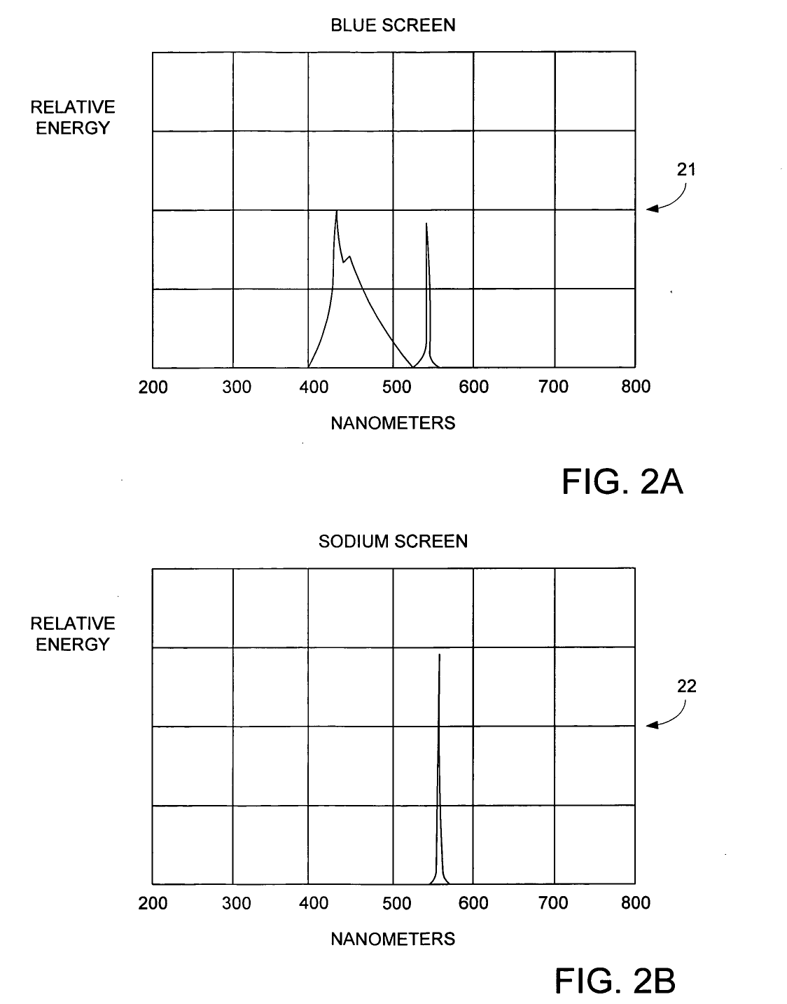

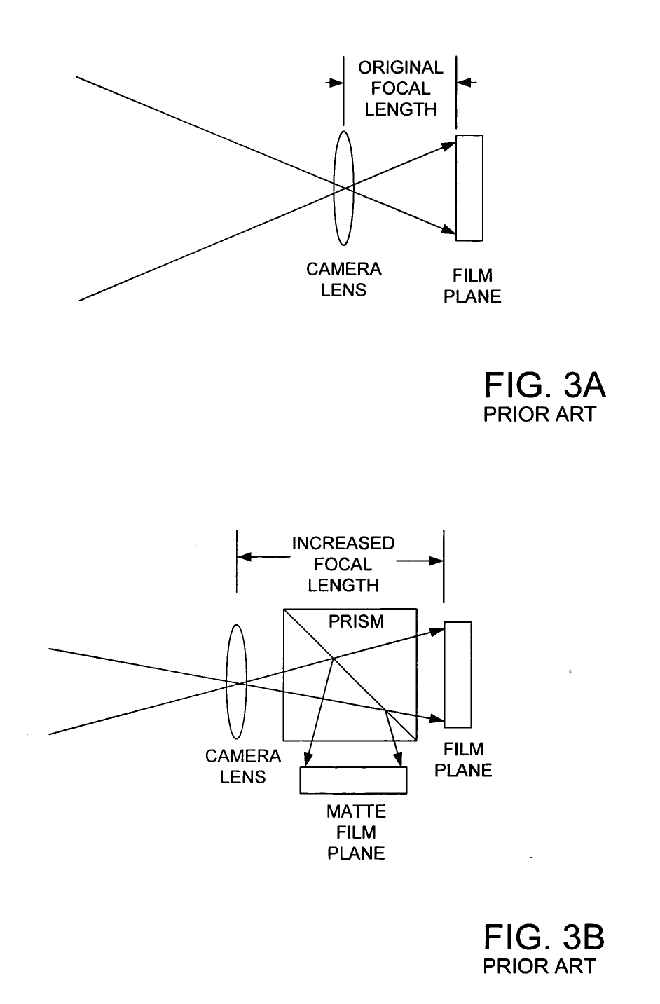

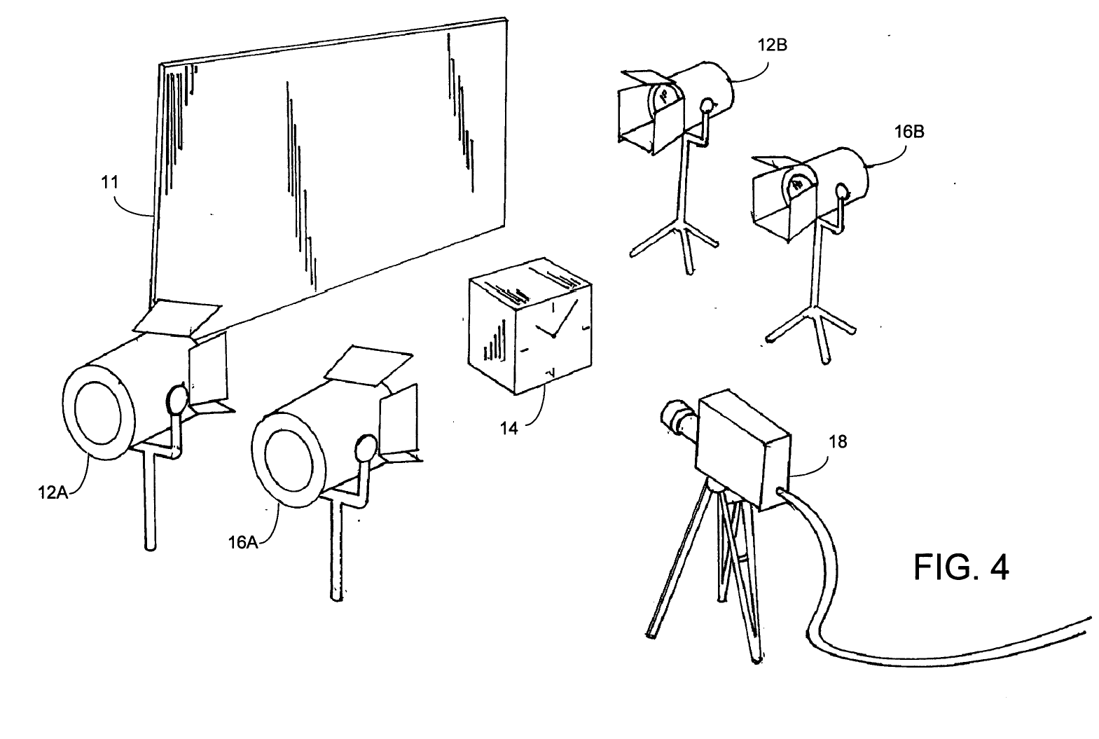

In various embodiments, low pressure sodium vapor light bulbs are used, as opposed to high pressure sodium vapor light bulbs. In such embodiments, low-pressure sodium vapor light bulbs provide the narrow band characteristics illustrated in FIG. 2B, above. The inventor notes that it is currently very difficult to obtain low-pressure sodium vapor bulbs in the United States. Most applications of sodium vapor lighting in the US are for high-pressure sodium vapor bulbs, and commonly used for street lighting, and the like. To obtain low-pressure sodium vapor bulbs for testing purposes, the inventor eventually located a company in the United States from the Internet (www.candelacorp.com) that provided these bulbs.

Low pressure sodium lights are currently believed to be the highest efficacy commercial lamps available, and rated at 160-180 lumens per watt. By comparison, tungsten halogen lamps 16A and 16B, are rated at approximately 26 lumens per watt. Accordingly, much smaller wattage sodium lamps may be utilized in embodiments of the present invention, resulting in energy savings and cost savings. Additionally, the film sets will have lower temperatures making it more conducive for actors and crew members.

In various embodiments of the present invention sodium vapor illumination sources 12A and 12B, and the like are used to illuminate backing 11 to provide as uniform a brightness range as is practical. In various embodiments “spill light” from the sodium vapor illumination sources should be prevented from illuminating the foreground subject 14. Common methods for doing this include strategic placement of the sources and/or through the use of light inhibitors, such as barn doors, as illustrated in FIG. 4. In a similar manner, in various embodiments it is desirable that full-spectrum light from tungsten halogen lamps 16A and 16B, which illuminate foreground subject 14, be kept from “spilling” onto backing 11.

In FIG. 4, a High Definition (HD) digital camera 18 having a resolution of 1960×1080 is utilized to record an image of the scene. As will be described below, digital camera 18 includes a prism assembly and an imaging sensor that allows the output of separate red, blue, and green channels, as well as the real-time output of sodium-screen mattes, in real-time, on a “sodium channel” (alpha channel). In various embodiments, HD digital camera 18 outputs RGB and S channel image in a “raw” file format, thereby preserving the full color and tonal range of the image. This allow the unique specular characteristics of the sodium illuminated backing 11 to be digitally captured/determined in real-time without any post-processing or compression.

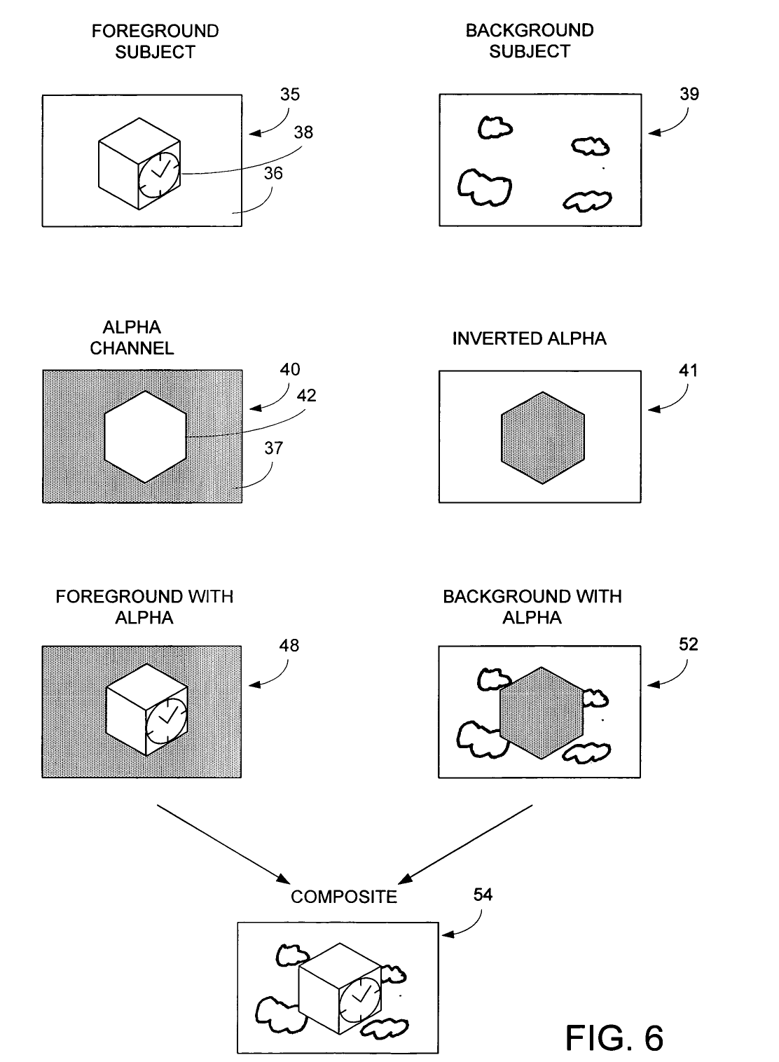

In various embodiments, a filter which transmits wavelengths of light from low-pressure sodium vapor bulbs may be incorporated into the internal optics of HD camera 18. In such embodiments, the output of the sodium channel will produce a gray scale alpha channel matte such as illustrated in image 40 in FIG. 6 as part of the image recording process in real-time. Therefore, almost immediately after the take has been shot, an original color image, such as image 35 and an alpha channel image, such as image 40 maybe downloaded in for real-time review, and stored for the purpose of compositing.

In various embodiments, because the sodium channel information includes gray scale data, the user may automatically or manually adjust the alpha channel so that the regions of the image that are known to represent the sodium-illuminated backing is assigned a value of zero, or no luminance, e.g. dark region 37, and the foreground subject a value of one, or full luminance, e.g. bright region 42. In various embodiments, regions in an image may have values between one and zero, for example, a blurred foreground subject edge due to motion, would be given a value between zero and one. In various embodiments, the user can automatically or manually adjust the value through the use of levels manipulations in conventional compositing software. Accordingly, the alpha channel would show varying degrees of gray tonalities where this mix is evident.

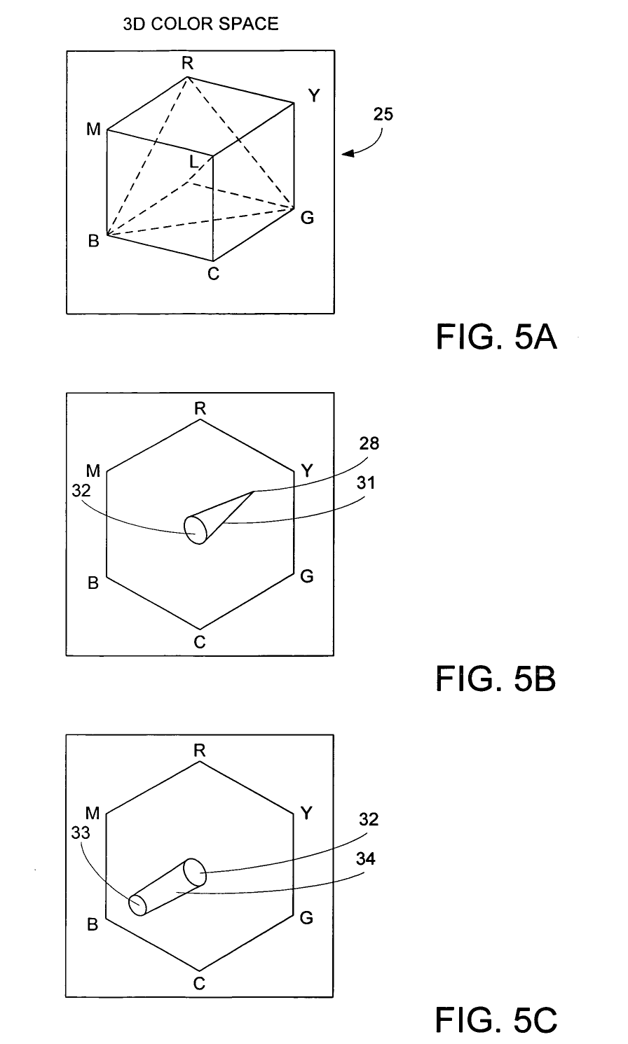

FIGS. 5A-C illustrate thee-dimensional representations of visible color space. In these graphs, e.g. graph 25, the comers of the cube represent chrominance information, including: red, yellow, green, cyan, blue and magenta. Additionally, the diagonal line L represents luminance data (i.e. similar to brightness). Plotting color into this three dimensional space is very accurate since it can account for all attributes of a color value, luminance and chrominance.

FIG. 5B illustrates portions of the 3D color space that a foreground subject would occupy and portions that sodium backing would occupy in the color space referring to FIG. 4. In this example, the colors of a foreground object/subject component is represented by a circle 32 in the middle of the color cube. Because clock 14 is gray in color, it has equal proportions of all color values, and when illuminated it occupies a specific brightness range along the L axis. In this example, the portion of the 3D color space used for sodium screen matte processing is represented by a dot 28 within the color cube. This is because the color range of the sodium illumination sources are narrow, and thus the color of backing 11 is also very narrow.

In various embodiments, the volume 31 within the 3D color space joining the circle 32 and dot 28 represents portions of the image that are a mixture of foreground lighting and background lighting. In various embodiments, mixture conditions may result from the movement of foreground subject within a scene, that creates blurred and/or partially transparent edges. As will be described below, these portions may be dialed-in or dialed-up (e.g. cleaned-up) during post-production, either automatically, or manually with the help of hardware and/or software.

FIG. 5C illustrates portions of the 3D color space that a foreground subject would occupy and portions that blue backing would occupy in the color space again referring to FIG. 4. As can be seen, the portion of the 3D color space that would be used for blue screen matte processing is represented by a circle 33 within the color cube. In various embodiments, circle 33 is larger than dot 28, because blue-screen processes rely upon a greater bandwidth of color.

In various embodiments, the volume 34 within the 3D color space joining the circle 32 and circle 33 represents portions of the image that are a mixture of foreground lighting and background lighting. Again, in various embodiments, mixture conditions may result from the movement of foreground subject within a scene, that creates blurred and/or partially transparent edges. Additionally, mixture condition may be the result of opaque or reflective objects, objects that are thin or have low density, or the like. Software algorithms, such as incorporated by Ultimatte, referred to above, must be used to address these conditions as described for blue or green screen processes.

FIG. 6 illustrates an example according to an embodiment of the present invention. More specifically, FIG. 6 illustrates a schematic representation of a digital compositing process according to embodiments of the present invention.

In various embodiment of the present invention, foreground subject color reproduction requires wavelengths of light in the sodium region to be subtracted from the overall color cast 32. A result is that circle 32 will reflect neutral colored tonal values. Additionally, in cases where “spill” from a sodium source strikes foreground subject 14, such light is typically absorbed by the sodium filters.

Additionally, in various embodiments, the spill suppressed foreground subject is now premultiplied with the alpha channel image 48. More generally, if A is the foreground subject and the sodium/alpha channel is M, then what is desired is A×M. Next, the background, image 39, is multiplied with the inverted alpha channel, image 41. More generally, if B is the background, then what is desired is: (1−M)×B. The final composite image, image 54, designated as 0, is a combination of the above two operations. More specifically: 0=(A×M)+[(1−M)×B].

In this example, an image 35 of a foreground subject 38 is shown recorded against a sodium illuminated backing 36. Using embodiments of the present invention, in real-time, a sodium screen matte image is generated on a camera alpha channel, as is shown in image 40. In this example, image 40, illustrates foreground subject 38 rendered as a white region 42, or full luminance, and portions of the image having light within the sodium region, being rendered as a dark region 37, or no luminance.

In this example, image 48 is then formed as a result of multiplying image 35 and image 40. As can be determined, this step cancels portions of the image that represent the sodium screen from the foreground element in the compositing process.

In this example, the background image 39 is also multiplied with an inverted alpha channel image 41 to form image 52. As seen in image 52, the compositing process then combines image 48 and 52. In various embodiments, multiple foreground images and multiple background images may be used in the composite.

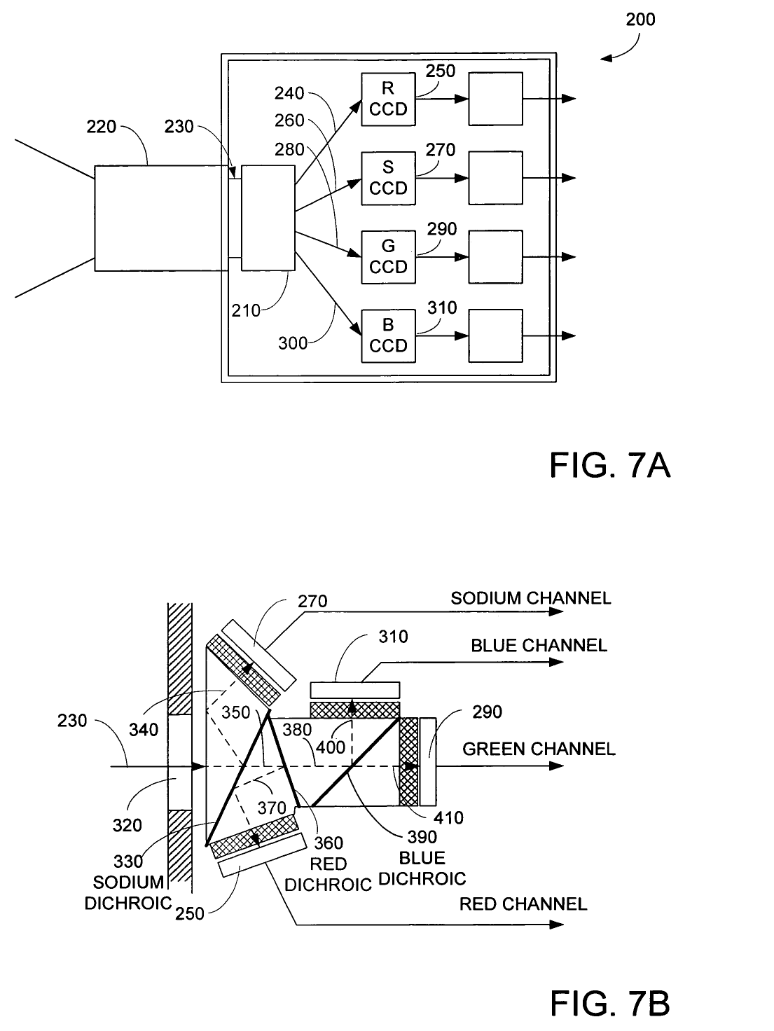

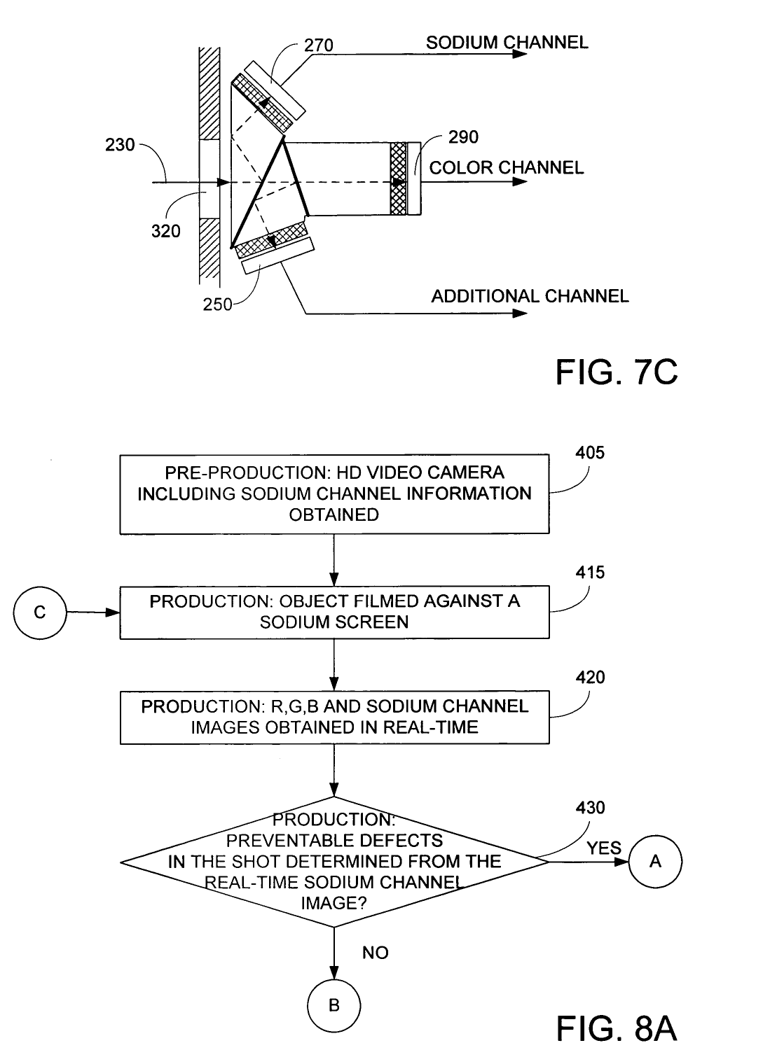

FIGS. 7A-C illustrate another embodiment of the present invention. More specifically, FIGS. 7A-C illustrate an optical/electrical configuration for a camera 200 including multiple image sensors and an improved prism assembly 210.

As illustrated in FIG. 7A, a lens 220 is typically affixed to camera 200, which receives light and provides images 230 to prism assembly 210. In turn, prism assembly 210 splits the light into specific regions of the light spectrum. As illustrated, prism assembly 210 outputs light 240 within the red region to a sensor 250, light 260 within a “sodium region” to a sensor 270, light 280 within the green region to sensor 290, and light 300 within the blue region to sensor 310.

In various embodiments, sensors 250, 270, 290 and 310 are used to convert incident light illumination into an electrical representation of the image. In embodiments of the present invention, sensors 250, 270, 290 and 310 are configured as charged-coupled devices (CCDs). In other embodiments, other types of sensors may be used, for example CMOS, and the like.

In various embodiments, any number of amplifiers, and other circuitry may also be added to camera 200. For example, signal amplifiers may be added to receive the respective output of sensors 250, 270, 290 and 310 and output modified signals. In one embodiment, output of camera 200 includes red, green, blue, and sodium channel information. In yet another embodiment, mixing circuits may be added to also receive the respective output of sensors 250, 270 and 290 and output modified signals. In one embodiment, output of camera 200 includes Luminance (Y), Cr, Cb, and sodium channel information. In various embodiments, it is contemplated that each sensor 250, 270, 290 and 310 are HD resolution (e.g. 1920×1080), or approximately 2K×1K. This resolution for each of the four CCDs is believed sufficient for current film making, as well as broadcast video. In other embodiments, sensors may have resolutions lower than HD, such as broadcast, or higher than HD, such as 3,840×2,400, approximately 4 megapixels, or the like.

In various embodiments of the present invention, camera 200 provides 4:4:4 (R:G:B or Y:Cr:Cb) color output, although in other embodiments, 4:2:2 and even 4:1:1 may also be used. In various embodiments, adding the Sodium channel on to the end, camera 200 may provide 4:4:4:4 output, 4:2:2:2 output, 4:2:2:4 output, or the like.

FIG. 7B illustrates a more detailed illustration of prism assembly 210 according to various embodiments of the present invention. As illustrated, light from image 230 is provided via aperture 320 to prism assembly 210.

Prism assembly 210 includes a sodium-reflecting dichroic coating 330 which selectively reflects light 400 within the sodium portion of the spectrum and transmits light 350 at other wavelengths. In various embodiments, the sodium portion of the spectrum includes wavelengths from approximately 589-590 nanometers. In other embodiments the sodium region may be approximately 585-595 nanometers, a region centered at approximately 589.6 nanometers, a region centered at approximately 589.0 nanometers, a yellow portion of the spectrum (approximately 560-590 nanometers), and the like.

Prism assembly 210 includes a red-reflecting dichroic coating 360 on one surface which selectively reflects light 370 within the red portion of the spectrum and transmits light 380 at other wavelengths. In various embodiments, the red portion of the spectrum includes wavelengths from approximately 600-700 nanometers.

Additionally, in this embodiment, prism assembly 210 includes a blue-reflecting dichroic coating 390 on one surface which selectively reflects light 400 within the blue portion of the spectrum, and transmits light 410 at other wavelengths. In various embodiments, the blue portion of the spectrum includes wavelengths from approximately 400-500 nanometers. In various embodiments, the green portion of the spectrum strikes CCD 290 and includes wavelengths from approximately 490-560 nanometers.

In various embodiments, a trimmer filter may be placed in front of CCDs 250, 290 and 310 to reduce the amount of light from the sodium region recorded by the respective channels. In various embodiments, dydimium (didymium) glass may be used as a trimmer filter, although other types of glass may also be used. In various embodiments, CCDs 250, 270, 290 and 310 are each monochromatic (e.g. black and white) CCDs. Additionally, these CCDs may have the same spatial resolution or different spatial resolution. Additionally, CCDs 250, 290 and 310 may have the same resolution, but a different resolution from CCD 270.

In other embodiments of the present invention, other arrangements of the channels are envisioned. For example, in one embodiment, CCDs 250, 270, 290, 310 may be respectfully the blue region, sodium region, green region, and red region; the blue region, the green region, the red region, the sodium region; or other combination. In such embodiments, the reflective/transmissive filters will, of course, be rearranged accordingly. Other arrangements of channels are also contemplated. In still other embodiments, trimmer filters may be integrated to the prism along with the dichroic coatings. In such examples, coatings 360, and 390 not only reflect light within a restricted range, but also absorb light within the sodium range.

The inventor of the present invention has determined that the typical ASA speed rating of CCDs 250, 270, 290 and 310 is approximately ISO 400. Thus, although the sodium region trimmer filter and other coatings may reduce the amount of light reaching the respective CCDs, by about an f-stop, the resulting ASA speed will reduced to about ISO 200, which conforms to light levels currently used for traveling matte shots.

Additionally, the inventor notes that with various embodiments of the present invention, the focal length of the digital video camera should not need to be modified to include the sodium region filter and image sensor (e.g. CCD). Accordingly, providing such functionality to existing HD cameras should be able to be performed with little effect on existing optical systems.

FIG. 7C illustrates an alternative embodiment of the present invention. In this embodiment, a conventional prism assembly 320 available from many sources is shown. In this embodiment, at least two CCDs are provided, CCD 270 to receive light in the sodium region of the spectrum and CCD 290 to receive light other than in the sodium region. The remaining channel may be unused or dedicated for other imaging purposes. In various embodiments, CCDs 250, 270 and 290 may have the same resolution. In other embodiments, the resolutions may be different.

In various embodiments, the remaining channel may include another light sensing element, such as a CCD. In some examples, the CCD array may be a color image acquiring sensor that extends the gamut or range of colors captured by the camera, such as a CCD array with color filters such as yellow, cyan, and magenta; a CCD array with a single color filter, such as cyan; or any other color desired. In other examples, the CCD array may be used to extend the dynamic range of the camera. For example, the CCD array in the remaining channel may have smaller CCD sensor locations and be useful for capturing detail in brighter regions of an image.

In other embodiments, the transmitted light may be light from the sodium region and reflected light be the remaining light. In this embodiment, a dichroic coating 350 may be provided to reflect light from the sodium region onto CCD 330, and to transmit the remaining light. Additionally, a trimmer filter 360 may be provided in front of CCD 290 to reduce light from the sodium region.

In contrast to the CCDs in the embodiment in FIG. 7B, CCD 290 may be embodied as an RGB sensor in an Bayer-pattern array, as is common with single CCD chip video camera, such as consumer-level video cameras, or the like. In other embodiments, other arrangements of RGB sensing elements in CCD 340 are also contemplated.

In operation, CCD 270 is used to capture a high resolution image of the matting image in real-time, and CCD 290 is used to capture a lower resolution red image, blue image, and green image. In various embodiments, RAW RGB data may be provided as an output, whereas in another embodiment, RGB data are interpolated and a “full-resolution” interpolated red image, blue image, and green image may be provided as outputs.

Embodiments described in FIG. 7C are believed sufficient for the demands of lower-budget “film” projects and/or sufficient for the demands for broadcast video/television and/or consumer-grade video cameras. This is in part because, most current high resolution broadcast video only provide 1280×760 resolution images, and because cameras including this embodiment would most likely be cheaper than cameras including the embodiment illustrated in FIG. 7B.

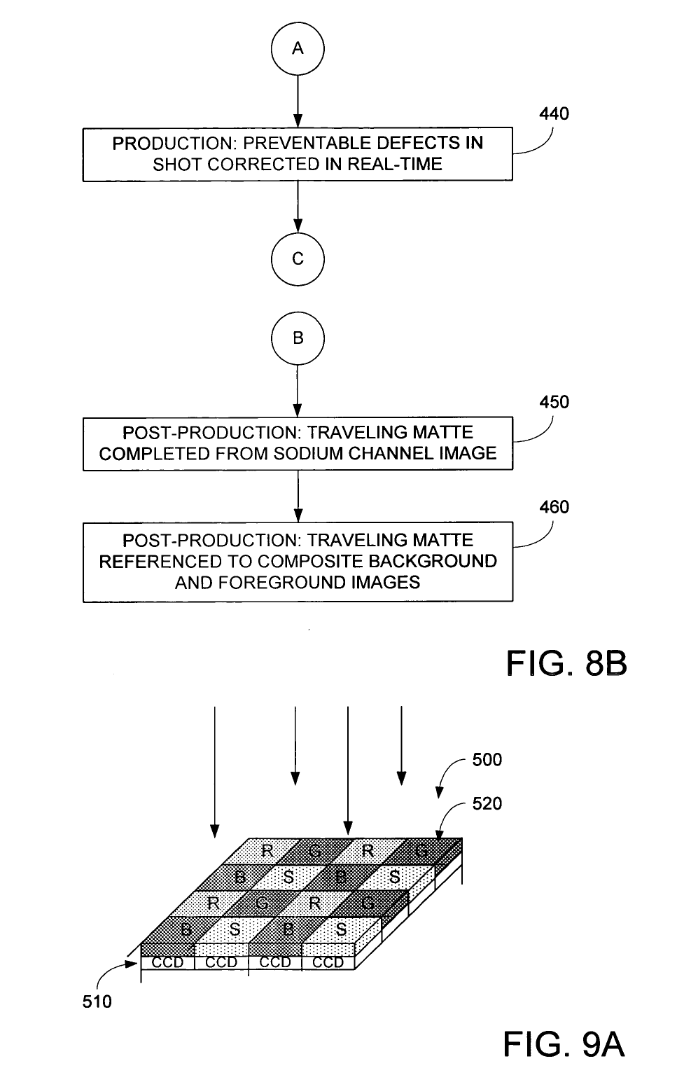

FIG. 8 illustrates a process according to an embodiment of the present invention. More specifically, FIG. 8 illustrates a sodium screen process for real-time digital traveling mattes. Initially, a HD digital video camera is configured according to the process described above, step 405. Next, an actor, for example, is recorded in front of a sodium screen, as illustrated in FIG. 4, above, step 415.

In various embodiments, in real-time, a red component image, a green component image, a blue component image, and a sodium component image is output from the video camera, step 420. As described above, the sodium component image represents the initially extracted matte.

Because the sodium component image can be seen in real time, defects in the sodium screen process image, described above, may be also be seen, (i.e. previewed) in real time, step 430. If there are seams in the image, foreground lights washing out the sodium screen lights, or other problems with the sodium screen process, the problem may be immediately corrected, step 440, and the scene may be immediately reshot, step 410. Reshooting the image to correct the problems is greatly advantageous over correcting all problems off-line, as is done with blue and green screen processes.

In other embodiments, the actual sodium component image can be reviewed before and during the recording process in step 415. Because the matte is substantially complete at this stage, defects in the backing, etc. can be determined in real time. Although blue and green screens may also be previewed before and during recording, because the actual matte screens are determined using lengthy computer algorithms and user tuning, the actual blue or green screen matte cannot be determined until well after the recording has completed. Accordingly, an accurate preview of defects cannot be performed using blue or green screen technology.

In various embodiments, if the initial sodium component image is satisfactory, additional fine tuning may still be performed on the matte, step 450. The fine-tuned matte is then used to combine the red, green, and blue component image and the background image to form the composited image, step 460.

From the inventor's experience with blue and green screen processes, he has found that a great majority (e.g. up to 90%) of the post-production “spill” suppression correction was a result of lighting problems, or the like. As discussed above, many of these problems in the shots could have been easily fixed and reshot if caught during recording. Accordingly, the inventor believes that with embodiments of the present invention, up to 90% of the post-production time for traveling matte processes can be reduced because for the first-time, the initial matte can be inspected in real-time.

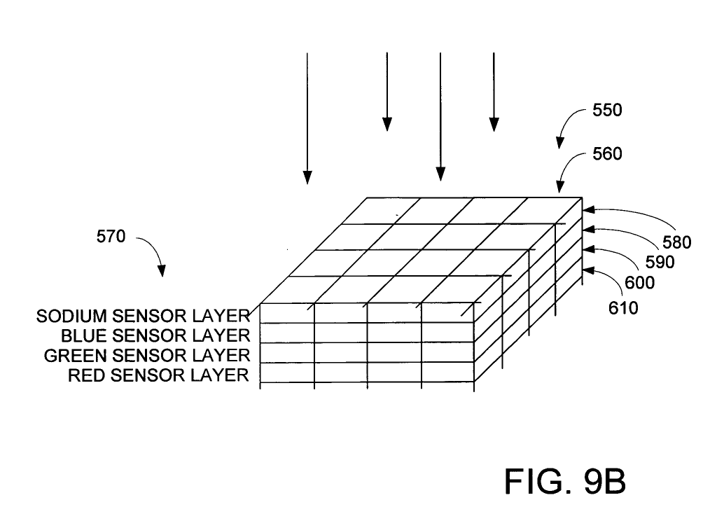

FIGS. 9A-B illustrate alternative embodiments of the present invention. More specifically, FIGS. 9A-B illustrate a single image sensor that may be used in various embodiments.

In FIG. 9A, a sensor 500 is illustrated including a number of light sensors 510 distributed horizontally across the semiconductor substrate. In various embodiments, sensor 500 may be based on CCD devices, CMOS devices, CID devices, or the like. As can be seen, colored filters 520 are disposed in front of light sensors 510. In embodiments of the present invention, colored filters 520 may include red filters, blue filters, and green filters as with conventional one-chip RGB sensors. In addition, “sodium” filters may also be provided to filter-out light in all regions but the narrow range of light provided by low pressure sodium lighting, described above. As a result, sensor 500 may be said to be an “RGBS” sensor.

In various embodiments, as illustrated, a Bayer-type pattern may be used for the distribution of filters across sensor 500. In other embodiments, any other “regular” distributed arrangement of filters is contemplated. In various configurations, RAW RGBS data may be output from a camera including sensor 500, or in other embodiments, interpolated RGBS data may be output. In other embodiments, a striped RGBS pattern may be used for the distribution of filters across an imaging sensor.

Cameras including sensor 500 are believed to be suitable for low-budget film projects as well as suitable for broadcast video.

In FIG. 9B, a sensor 550 is illustrated including a number of light sensors 560 distributed horizontally across, and vertically into the semiconductor (e.g. silicon) substrate. In these embodiments, light sensors 570 within a horizontal plane are used to capture light from a particular region of the spectrum. Further light sensors within different horizontal planes are used to capture light from different regions of the spectrum.

In this example, light from the sodium region is captured in light sensors in horizontal plane 580, light from the blue region is capture in light sensors in horizontal plane 590, light from the green region is captured in light sensors in horizontal plane 600, and light from the red region is captured in light sensors in horizontal plane 610. The inventor believes that embodiments of the present invention may be based upon multiple well technology developed by Foveon, Inc. or similar technology, as described in U.S. Pat. No. 5,965,875, incorporated by reference herein. In other embodiments, the ordering of the layers, above, may be different

Cameras including sensor 550 should be able to provide full HD resolution images of RGBS data, and should be suitable for all “film” projects as well as suitable for broadcast video, or the like.

In other embodiments, combinations or sub-combinations of the above disclosed embodiments can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention. For example, in many of the embodiments described above referred to HD resolution digital video cameras, however it should be understood that in light of the above disclosure, one of ordinary skill in the art may envision embodiments having resolutions lower than HD. For example, broadcast-grade, and consumer-grade digital video cameras, having lower resolutions may also be used in various embodiments. These embodiments may use 4 imaging sensors (e.g. CCDs), 2 imaging sensors (e.g. CCDs, CMOS), 1 imaging sensor, or the like, to output in real-time sodium channel information, as well as color channel information. In still other embodiments, implementations may be based on digital still cameras, such that sodium channel information is also available in real-time or near real-time.

Embodiments of the present invention need not be dedicated to the sodium-screen uses. Unlike the dedicated blue and /or green-screen hardware and software systems mentioned in the background, embodiments should provide standard RGB channel data. Accordingly, when shooting a feature, a camera constructed as described above, could be used for filming “regular” shots, and could also be used for sodium-screen shots, as described above. As a result, production of the feature would require less video hardware, and should be less expensive.

In light of the above patent disclosure, it is believed that composited images using the hardware and techniques described herein will be more realistic and more natural looking than was previously achievable with blue or green screen hardware or software. This is believe to be possible because of the real-time traveling matte formation, real-time error detection and the ability to instantly reshoot the scene. Additionally, this is believed to be possible because much more post-production time can be freed-up from correction errors in matte extraction and dedicated to matte quality and details.

In various embodiments, real-time compositing are also expected to yield greater quality images. Current blue and green screen compositing technology, such as chroma-key or Luma-key systems, often used by weather forecasters, or the like typically produce poor results. Commonly observed problems include shadows of the forecasters on the blue screen breaking-up the desired background image, portions of the background image appearing on the forecaster, or the like. Using sodium screen processes according to the above descriptions are believed to be able to provide higher quality real-time composited images. Reasons for this include the narrow range of sodium light being used, the novel real-time sodium screen matte extraction process and cameras, and the like, as described herein.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A digital video camera comprises:
a light receiving region configured to receive light having a plurality of frequencies in the form of an image, wherein the light receiving region is also coupled to receive a lens;
a first CCD element configured to receive light primarily within a red region of light spectrum, and configured to convert received light into first electrical signals;
a second CCD element configured to receive light primarily within a blue region of the light spectrum, and configured to convert received light into second electrical signals;
a third CCD element configured to receive light primarily within a green region of the light spectrum, and configured to convert received light into third electrical signals;
a fourth CCD element configured to receive light primarily within a sodium region of the light spectrum, wherein the sodium region of the light spectrum comprises a region of spectrum of light provided by low-pressure sodium vapor light, and wherein the fourth CCD element is configured to convert received light into fourth electrical signals in real-time; and
a prism coupled to the light receiving region, to the first CCD element, to the second CCD element, to the third CCD element, and to the fourth CCD element, wherein the prism is configured to receive the light at in input portion, and direct the light within the red region to the first CCD element in response to the light, direct the light within the blue region to the second CCD element in response to the light, direct the light within the green region to the third CCD element in response to the light, and direct the light within the sodium region to the fourth CCD element in response to the light.

2. The digital video camera of claim 1 wherein the prism comprises a plurality of di-chroic coatings including:
a first dichroic coating configured to reflect the light within the red region of the light spectrum to the first CCD element; and
a second dichroic coating configured to reflect the light within the blue region of the light spectrum to the second CCD element; and
a third dichroic coating configured to reflect the light within the sodium region of the light spectrum to the fourth CCD element.

3. The digital video camera of claim 1 further comprising:
a plurality of sodium region filters, wherein each of the plurality of sodium region filters are configured to attenuate intensity of light within the sodium region of the light spectrum;
wherein a first sodium region filter is disposed in an optical pathway between the input portion of the prism and the first CCD element;
wherein a second sodium region filter is disposed in an optical pathway between the input portion of the prism and the second CCD element; and
wherein a third sodium region filter is disposed in an optical pathway between the input portion of the prism and the third CCD element.

4. The digital video camera of claim 3
wherein the first sodium region filter comprises dydimium glass.

5. The digital video camera of claim 1 wherein the sodium region of the light region is selected from a group consisting of: approximately 589 nanometers to approximately 590 nanometers, approximately 585 nanometers to approximately 595 nanometers, a region centered at approximately 589.6 nanometers, a region centered at approximately 589.0 nanometers.

6. The digital video camera of claim 1 further comprising an output portion coupled to the first CCD element, the second CCD element, the third CCD element, and the fourth CCD element, wherein the output portion is configured to receive the first electrical signals and to output a red image in real-time, wherein the output portion is configured to receive the second electrical signals and to output a blue image in real-time, wherein the output portion is configured to receive the third electrical signals and to output a green image in real-time, and wherein the output portion is configured to receive the fourth electrical signals and to output a matte image in real-time.

7. The digital video camera of claim 1 further comprising an output portion coupled to the first CCD element, the second CCD element, the third CCD element, and the fourth CCD element, wherein the output portion is configured to receive the first electrical signals, the second electrical signals, the third electrical signals, and the fourth electrical signals, and wherein the output portion is configured to output a Y image, a Cr image in real-time, and a Cb image in real time in response to the first electrical signals, the second electrical signals, and the third electrical signals, wherein the output portion is configured to receive the fourth electrical signals and to output a digital matte image in real-time.

8. The digital video camera of claim 1 wherein the first CCD element, the second CCD element, the third CCD element, and the fourth CCD element each have greater than approximately 2 million CCD elements.

9. A method for an imaging device comprises:
receiving in a lens assembly an image comprising light having a plurality of wavelengths;
directing the light having a plurality of wavelengths into a prism;
providing light having wavelength primarily within a sodium region of a spectrum to a first semiconductor optical sensor from the prism in response to the light having the plurality of wavelengths, wherein the sodium region of the light spectrum comprises a region of spectrum of light provided by low-pressure sodium vapor light.
providing light having wavelength within a blue region of a spectrum to a second semiconductor optical sensor from the prism in response to the light having the plurality of wavelengths;
providing light having wavelength within a red region of the spectrum to a third semiconductor optical sensor from the prism in response to the light having the plurality of wavelengths;
providing light having wavelength within a green region of the spectrum to a fourth semiconductor optical sensor from the prism in response to the light having the plurality of wavelengths.

10. The method of claim of claim 9 wherein providing light having wavelength within the blue region of the spectrum to a second semiconductor optical sensor further comprises substantially filtering-out light within the sodium region of the spectrum.

11. The method of claim 10 wherein the sodium region of the light region is selected from a group consisting of: approximately 589 nanometers to approximately 590 nanometers, approximately 585 nanometers to approximately 595 nanometers, a region centered at approximately 589.6 nanometers, a region centered at approximately 589.0 nanometers.

12. The method of claim 9 wherein the first semiconductor optical sensor is selected from a group consisting of: CCD sensor, CMOS sensor.

13. The method of claim 12 wherein the first semiconductor optical sensor comprises greater than approximately 2 million sensor elements.

14. The method of claim 9 further comprising:
substantially simultaneously:
providing sodium region image data from the first semiconductor optical sensor in real-time in response to the light within the sodium region; and
providing green region image data from the fourth semiconductor optical sensor in real-time in response to the light within the green region.

15. The method of claim 14 further comprising combining the green region image data and background image data to form a composited image in response to the sodium region image data.

16. The method of claim 15 further comprising:
storing the composited image in a tangible media;
retrieving the composited image; and
displaying the composited image.

17. A digital camera comprises:
a light receiving region configured to receive light having a plurality of wavelengths;
a first sensor element configured to receive light primarily within sodium-region wavelengths of light, wherein the sodium-region wavelengths of light comprises wavelengths of light provided by low-pressure sodium vapor lights, wherein the first sensor element is configured to convert primarily the sodium-region wavelengths of light into a matte image in real-time; and
a second sensor element configured to receive remaining-region wavelengths of light, wherein the remaining-region wavelengths of light comprise the light having the plurality of wavelengths with attenuated sodium-region wavelengths of light, wherein the second sensor element is configured to convert the reaming-region wavelengths of light into a color image in real-time; and
a prism coupled to the light receiving region, to the first sensor element and to the second sensor element, wherein the prism is configured to receive the light at in input portion, direct the light within the sodium-region wavelengths of light to the first sensor element in response to the light, and direct the remaining-region wavelengths of light to the second sensor element in response to the light.

18. The digital camera of claim 17 wherein the second sensor element is selected from a group consisting of: an RGB striped sensor, an RGB array sensor.

19. The digital camera of claim 17 wherein a resolution of the first sensor element and a resolution of the second sensor element are selected from a group consisting of: same, different.

20. The digital camera of claim 19 wherein the first sensor element comprises greater than approximately 2 million elements.
